(19) United States
(12) Patent Application Publication
(10) Pub. No.: US 2015/0197417 A1
(43) Pub. Date: Jul. 16, 2015

(54) SELF-FILLING REFRIGERATOR WATER PITCHER

(71) Applicant: HAIER AMERICA RESEARCH AND DEVELOPMENT CO., LTD., CAMDEN, SC (US)

(72) Inventors: Michael E. STAGG, Evansville, IN (US); Matthew W. HARTMANN, Evansville, IN (US)

(73) Assignee: HAIER AMERICA RESEARCH AND DEVELOPMENT CO., LTD., CAMDEN, SC (US)

(21) Appl. No.: 14/156,773

(22) Filed: Jan. 16, 2014

(51) Int. Cl. B67D 7/36; B67D 7/02

(52) U.S. Cl. CPC B67D 7/362; B67D 7/02

(57) ABSTRACT

A system and method that supplies fluid, the system comprising a removable container having a magnet, a dispenser defining a cavity to receive the removable container, a sensor disposed adjacent to the cavity, and a control circuit configured to supply fluid to the removable container in response to the sensor (1) detecting a presence of the magnet and (2) detecting that a change in flux of the magnet is greater than a predetermined amount.

### BACKGROUND

Water pitchers are used in everyday lives of consumers. Consumers particularly may enjoy cold water in the pitchers and as such, fill the pitcher up with water and then place the pitcher in the refrigerator. When the consumers get the pitcher out of the refrigerator and consume some of the water, they have to determine if the water has gone below a certain level and whether the pitcher should be refilled (or if it is worth the hassle to refill at that time). They then have to refill the pitcher with water and then put the pitcher back in the refrigerator. This can be a hassle especially for those consumers on the go or those who are not good at remembering to refill the pitchers.

Thus, the pitcher of water may not always been full when the consumer wants water, and in fact, may not have even enough water for one cup.

Some consumers will employ multiple water pitchers to correct the above issues, but that solution takes up valuable shelf space in the refrigerator.

### SUMMARY

Embodiments of the invention provide a solution to the above problems. In some embodiments, a liquid dispenser and removable container system is provided herein that uses magnets with hall effect sensors to automatically supply fluid to a removable container when the removable container is placed in the refrigerator.

Exemplary embodiments according to this disclosure can include a dispenser and removable container system, the system can comprise a removable container comprising a first magnet and a second magnet, a dispenser defining a cavity to receive the removable container, the dispenser comprising a sensor disposed adjacent to the cavity, a liquid supply line that is configured to supply fluid to the removable container, a valve that regulates an amount of fluid dispensed from the liquid supply line into the removable container and a control circuit configured to open the valve and supply the fluid through the liquid supply line to the removable container in response to the sensor (1) detecting a presence of the first magnet and (2) detecting that a change in flux of a second magnet is greater than a predetermined amount.

The removable container can include a cover, and the first magnet can be disposed in the cover. The removable container can include an inner housing, the inner housing can have a plurality of holes to allow the fluid to enter the inner housing and the second magnet can be disposed in the inner housing and float on top of the fluid. The inner housing can include a float housing, wherein the float housing can have a cap which secures the second magnet in the float housing.

The sensor can include a first sensor and a second sensor, the first sensor detects the presence of the first magnet, and the second sensor detects the change in flux of the second magnet. The first magnet and the second magnet can be separate magnets. Alternatively, the first magnet and second magnet can be the same magnets.

The sensor can comprise a hall effect sensor. The sensor can detect the first magnet indicating that the removable container is present in the cavity of the dispenser. The sensor can also detect the change in flux of the second magnet within a predetermined time period.

The control circuit can close the valve and prevent the supply of fluid to the removable container in response to the sensor detecting the change in flux of the second magnet to be substantially zero. The control circuit can also close the valve and prevent the supply of fluid to the removable container in response to the sensor detecting the flux of the first magnet to be substantially zero.

Embodiments further may include a system that supplies fluid, the system comprising a removable container having a magnet, a dispenser defining a cavity to receive the removable container, a sensor disposed adjacent to the cavity, and a control circuit configured to supply fluid to the removable container in response to the sensor (1) detecting a presence of the magnet and (2) detecting that a change in flux of the magnet is greater than a predetermined amount.

Embodiments may yet further include a method of replenishing fluid in a removable container, the method comprising inserting the removable container in a fluid dispenser, detecting, by a sensor in the fluid dispenser, a presence of at least one magnet in the removable container and supplying fluid to the removable container when (1) the presence of the at least one magnet is detected and (2) a change in flux of the at least one magnet is greater than a predetermined amount.

### BRIEF DESCRIPTION OF THE DRAWINGS

Exemplary embodiments are described herein with reference to the following figures wherein:

FIG. 1 illustrates a perspective view of an exemplary dispenser and removable container system in an exploded view according to one embodiment;

FIG. 2 illustrates a perspective view of an exemplary dispenser and removable container system in a closed state according to one embodiment; and

FIG. 3 is a flow diagram illustrating an exemplary method for automatically replenishing fluid in a removable container according to one embodiment.

### DETAILED DESCRIPTION OF THE EMBODIMENTS

The following exemplary embodiments refer to the detecting and/or dispensing of fluid in a dispenser and removable container system by the use of hall effect sensors. It should be appreciated that, although the exemplary embodiments according to this disclosure can be applicable to specific applications, the depictions and/or descriptions included in this disclosure are not intended to be limited to any specific application. For example, the exemplary embodiments are not limited to a particular environment or use, and can be used for dispensing fluid in refrigerated storage, non-refrigerated storage, chilled storage, heated storage or storage at ambient conditions. A wide variety of fluids can be used in these conditions such as, for example, coffee, soft drinks and water. Accordingly, any system and method that can advantageously involve a dispenser and a removable container as described in an exemplary manner in this disclosure are contemplated.

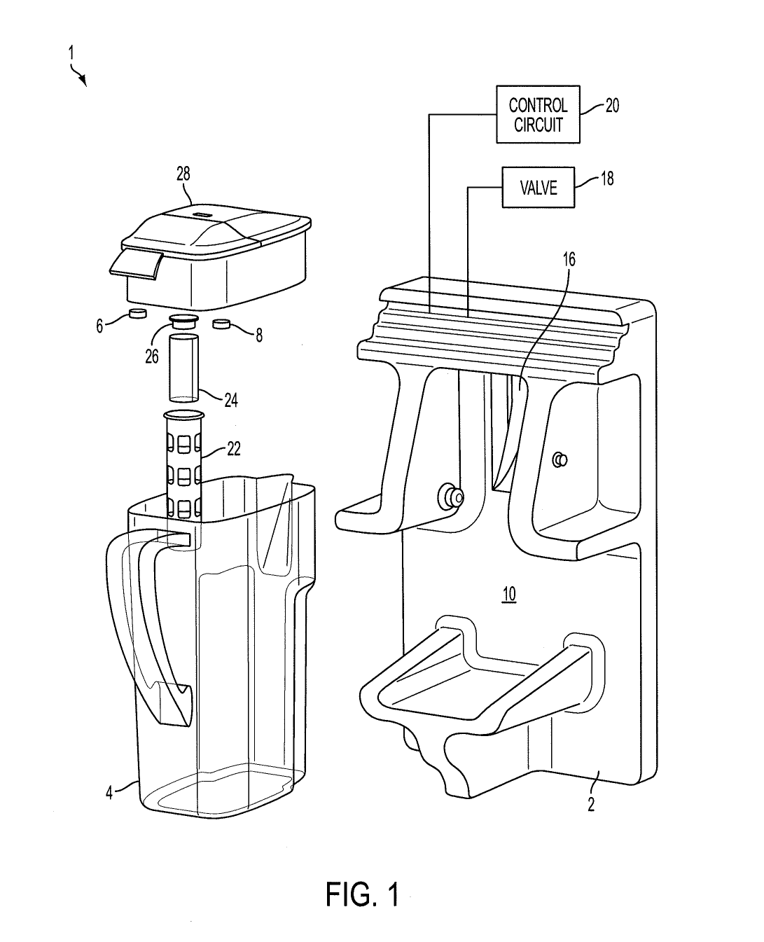

FIG. 1 illustrates a perspective view of the fluid supply system 1. The fluid supply system 1 can include a dispenser 2 and a removable container 4. The dispenser 2 can be any apparatus that dispenses any type of fluid into the removable container 4. In the illustrated exemplary embodiment, the dispenser 2 may be a portion of a refrigerator that dispenses water into the removable container 4, and the removable container 4 may be a water pitcher. However, a plurality of devices can be used. For example, the dispenser 2 can be a coffee dispenser that dispenses coffee into the removable container 4 being a coffee pot. As another example, the dispenser 2 can be a soft drink dispenser that dispenses a soft drink into the removable container 4 being a cup. Thus, the dispenser may be a device which is configured to automatically deliver fluids to the removable container 4 in response to one or more predetermined conditions being met.

The dispenser 2 can include a liquid supply line 16, a valve 18 and a control circuit 20 used to administer fluid to the removable container 4. The liquid supply line 16 can supply fluid to the removable container 4 when the removable container 4 is engaged and properly positioned in the dispenser 2. The valve 18 can regulate an amount of fluid to be dispensed from the liquid supply line 16 into the removable container 4. The valve 18 can connect the fluid source to the liquid supply line 16. The valve 18 can be controlled by a control circuit 20. As further discussed below, the control circuit 20 can receive various commands to open or close the valve 18 so that the flow of fluid into the removable container 4 can be controlled. The liquid supply line 16, valve 18 and control circuit 20 can be disposed in customary positions of a dispenser 2 such as in a cavity of a door, in a main housing of the dispenser 2 or other customary positions in a refrigerator.

The dispenser 2 can be defined by a cavity 10 that can receive the removable container 4. The cavity 10 can be an interior of the refrigerator, such as in a door of the refrigerator, for example. The cavity 10 can provide an enclosure for the removable container 4 to be engaged and secured to the dispenser 2. The cavity 10 in the door can also provide convenience for a user to access the removable container 4. The cavity 10 can include a bottom surface to support the removable container 4 and two side surfaces to align the removable container 4 with the liquid supply line 16. The cavity 10 can be sized to be slightly larger than the removable container 4 so that the removable container 4 can be effectively enclosed on a majority of the side surfaces.

This configuration can prevent the removable container 4 from inadvertently releasing from the cavity 10 and can prevent undesirable movement of the removable container 4 within the cavity 10. This configuration can also aid in securing the removable container 4 in the cavity 10. The cavity 10 can also be connected to the liquid supply line 16 so that when the removable container 4 is properly positioned in the cavity 10, the liquid supply line 16 is aligned to supply fluid to the removable container 4. The size and position of the cavity 10 can also ensure that the removable container 4 remains aligned with the liquid supply line 16 before, during and after liquid is dispensed.

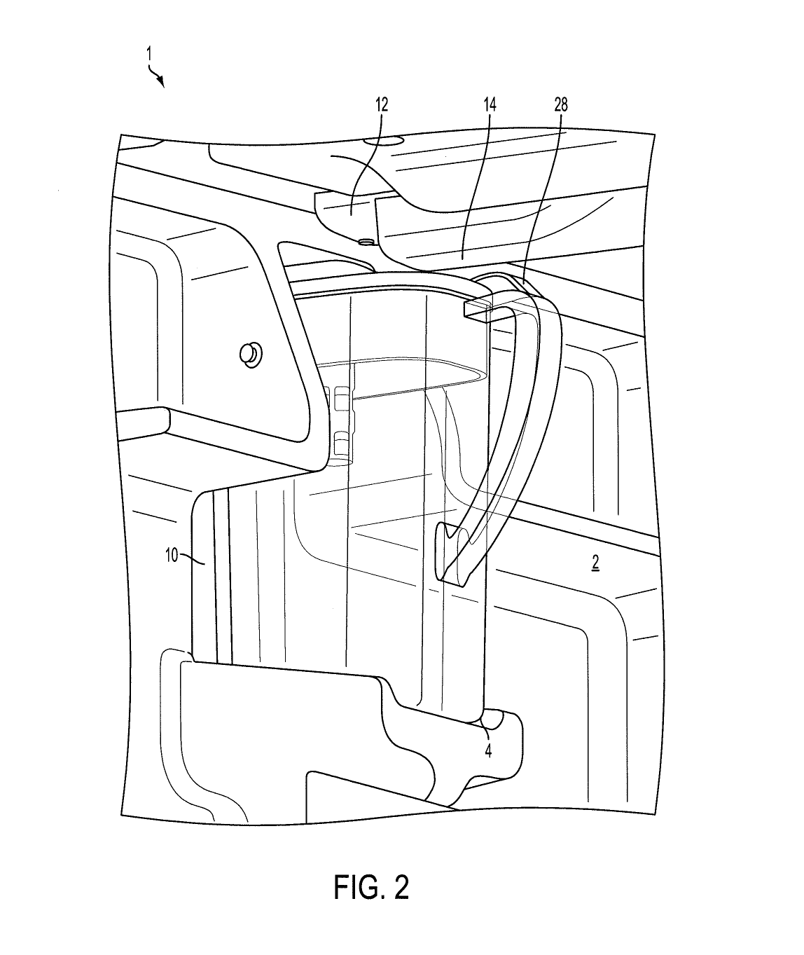

FIG. 2 illustrates a first sensor 12 and a second sensor 14 disposed in the dispenser 2 in a closed state (when the refrigerator door is closed). As discussed below, although the exemplary illustrative embodiment describes the use of two separate sensors 12, 14, only one sensor can be used to capture the information desired according to another embodiment.

The sensors 12, 14 can be hall effect sensors. A hall effect sensor may be a transducer that can vary its output (e.g., output voltage) in response to receipt of a magnetic field or magnetic flux. A hall effect sensor can be combined with circuitry to form a switching type device. The hall effect sensor measures the magnetic flux received and based on such magnetic flux, provides an output directional proportional to such magnetic flux. As the magnetic flux measured at the hall effect sensor increases, the output of the hall effect sensor may also increase proportionally. As the magnetic flux measured at the hall effect sensor decreases, the output of the hall effect sensor may also decrease proportionally. Thus, the hall effect sensor can effectively indicate a magnet's increasing or decreasing position relative to a point. Additionally, the hall effect sensor can simply detect the presence of a magnet.

The sensors 12, 14 can be disposed adjacent to the cavity 10 in a separate portion of the dispenser 2. Alternatively, the sensors 12, 14 can be disposed in the cavity 10. For example, sensors 12, 14 can be located at a top surface of the cavity 10. The sensors 12, 14 can be positioned in the dispenser 2 so that the sensors 12, 14 can be substantially aligned with magnets 6, 8, respectively, in the removable container 4 as discussed below. Additionally, in one embodiment, the sensors 12, 14 may be located as close to the magnets 6, 8 as possible. Such position and alignment can be advantageous so that accurate measurement is received.

The sensors 12, 14 can interface with the control circuit 20. Based on the detection received from the sensors 12, 14, the control circuit 20 can receive commands from the sensors 12, 14 to open or close the valve 18 so that fluid flow into the removable container 4 can be controlled.

FIG. 1 also illustrates the removable container 4 in further detail. The removable container 4 includes a first magnet 6 and a second magnet 8. As discussed below, although the exemplary embodiment describes the use of two separate magnets 6, 8, only one magnet may be employed according to another embodiment.

The first magnet 6 can be a magnet fixed at a position in the removable container but need not be limited as such and therefore can alternatively be able to move. In one embodiment, the first magnet 6 may be fixably located in a container cover 28 of the removable container 4. Specifically, the first magnet 6 can be secured in a closed cavity of the container cover 28 so that the first magnet 6 cannot accidentally be separated from the container cover 28. The first sensor 12 can detect the first magnet 6 to determine the presence of the removable container 4 in the dispenser 2. The first sensor 12 can notify the control circuit 20 of a positive condition indicating that the removable container 4 is disposed in the dispenser 2.

The removable container 4 can also include an inner housing 22. The inner housing 22 can be disposed in the removable container 4 and can be attached to an inner surface of the removable container 4. The inner housing 22 can be fixed within the removable container 4 so that the inner housing 22 cannot move with respect to the removable container 4. The inner housing 22 can include a plurality of holes so that fluid in the removable container 4 can also flow into the inner housing 22.

The inner housing 22 can include a float housing 24 which can have a float cap 26. The second magnet 8 can be disposed in the float housing 24 and secured by the float cap 26 so that the second magnet 8 cannot be displaced from the float housing 24. The float housing 24 can be sized to closely fit an inner diameter of the inner housing 22. When fluid enters into the removable container 4, the fluid can also flow into the inner housing 22. The second magnet 8 can float on top of the fluid in the float housing so that the second magnet 8 can move up and down (relative to the second sensor) in the float housing 24 based on the amount of fluid in the removable container 4. As such, the closer the second magnet 8 is to the second sensor 14, the more fluid there is in the removable container 4.

The range of movement of the second magnet 8 in the float housing 24 can be fixed so that the second magnet 8 in the float housing 24 can extend from a top surface of the removable container 4 to a bottom surface of the removable container 4. When the removable container 4 is filled or mostly filled with fluid, the second magnet 8 in the float housing 24 can float on the fluid and be positioned proximate to the top surface of the removable container 4. In this position, the second magnet 8 in the float housing 24 cannot move upward any further.

When the removable container 4 is empty, the second magnet 8 in the float housing 24 can be disposed at or proximate to the bottom surface of the removable container 4. The second sensor 14 can detect the position of the second magnet 8 and can thereby determine the amount of fluid present in the removable container 4. The second sensor 14 can notify the control circuit 20 indicating the amount of fluid in the removable container 4.

The second sensor 14 can also determine a change in flux of the second magnet 8 over a predetermined period of time. The change in flux is calculated by consecutive measurement of the flux of the second magnet 8 within the predetermined period of time. The predetermined period of time to calculate the change in flux of the second magnet 8 by the second sensor 14 can be any prescribed amount of time. For example, the predetermined period of time can range between one and thirty seconds. In one embodiment, the predetermined period of time can be between one and five seconds. In another embodiment, the predetermined period of time can be between one millisecond and one second. The second sensor 14 can receive a continuous reading of the flux of the second magnet 8 depending on the predetermined period of time to calculate the change in flux of the second magnet 8. The second sensor 14 can notify the control circuit 20 of a positive condition (e.g., the change in flux is greater than a predetermined amount) indicating that the removable container 4 is not full of fluid.

In an alternate embodiment, the second magnet 8 and the first magnet 6 can be the same magnet in that the second magnet 8 can also perform the function of the first magnet 6 to determine the presence of the removable container 4 in the dispenser 2. In this configuration, one sensor 12 or 14 and one magnet 8 can be used to determine (1) the presence of the removable container 4 in the dispenser 2, and (2) the amount of fluid in the removable container 4 by determining the change in flux of the second magnet 8 over a predetermined period of time.

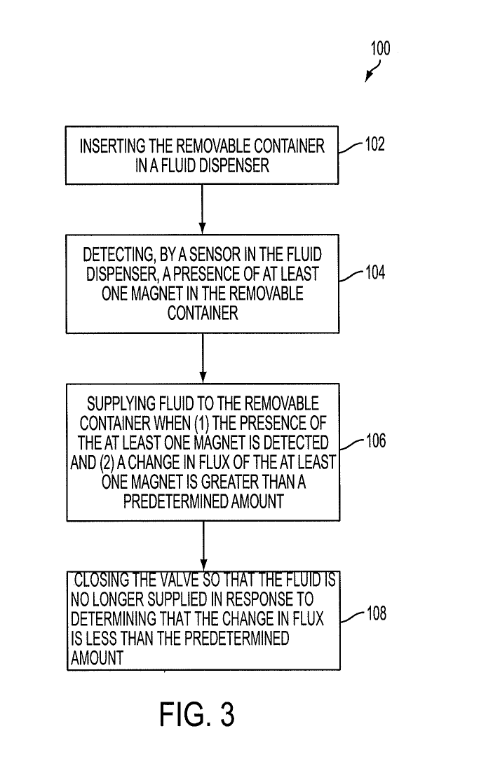

FIG. 3 illustrates exemplary method steps 100 describing the operation of the fluid supply system 1. When the removable container 4 is disposed in the dispenser 2 (Step 102), the first sensor 12 can detect the presence of the first magnet 6 (Step 104). Under this condition, the first sensor 12 can notify the control circuit 20 of a positive condition indicating that the removable container 4 is disposed in the dispenser 2.

Next, the fluid supply system 1 can begin to dispense fluid for a predetermined period of time, as discussed above. When the fluid is dispensed for the predetermined period of time, the second sensor 14 can determine a change in flux of the second magnet 8. The change in flux of the second magnet 8 represents the amount by which the second magnet 8 moves due to the additional fluid being supplied to the removable container 4. The change in flux can indicate whether the removable container 4 is filled with fluid (or an error condition). If the change in flux is greater than a predetermined threshold and not substantially zero, then the removable container 4 is determined to not be full with fluid and is thus, the valve should be opened to fill the container 4 with fluid (Step 106).

If the change in flux is substantially zero or less than the predetermined threshold, then the removable container 4 is full with fluid (or the second magnet is stuck in the float housing) and no more fluid should be supplied (Step 108).

If the change in flux is greater than a predetermined value, the second sensor 14 can notify the control circuit 20 of a positive condition indicating that the removable container 4 is not full with fluid and thus is being filled with fluid (Step 106).

The predetermined amount of the change in flux can be dependent on an incoming fluid flow rate from the liquid supply line 16 of the dispenser 2 and the volume of the removable container 4. These parameters can be used to determine the predetermined amount or rate at which the second magnet 8 should move in the removable container 4 when the removable container 4 is being filled with fluid. In one embodiment, the predetermined amount can be slightly less than the rate at which the second magnet 8 should move in the removable container 4 when the removable container 4 is being filled with fluid. Thus, when the change in flux is greater than the predetermined value, the second sensor 14 can notify the control circuit 20 of a positive condition indicating that the removable container 4 is not full with fluid and thus is being filled with fluid.

Accordingly, if (1) the first sensor 12 notifies the control circuit 20 of the positive condition indicating that the removable container 4 is present in the dispenser 2 (Step 104) and (2) the second sensor 14 notifies the control circuit 20 of the positive condition indicating that the removable container 4 is not full with fluid, then the control circuit 20 can command the valve 18 to open and allow the dispenser 2 to dispense fluid into the removable container 4 (Step 106). The valve 18 can continue to remain open so that the fluid can dispense into the removable container 4 until one of these conditions is not positive (Step 108).

This configuration can advantageously provide fluid to the removable container 4 automatically without user intervention. In other words, a user does not have to manually fill the removable container 4 with fluid. The removable container 4 can also be filled regardless of how much fluid is in the removable container 4 when the removable container 4 is placed in the dispenser 2. Additionally, the removable container 4 can be filled in the environment of the dispenser 2. Thus, when the dispenser 2 is a refrigerator, the removable container 4 can be filled with water at a refrigerated temperature. Accordingly, the water in the removable container 4 can be immediately served at a chilled temperature.

If the first sensor 12 does not detect the first magnet 6, the first sensor 12 detects a substantially zero flux and the first sensor 12 determines that the removable container 4 is not present in the dispenser 2. In this condition, the valve should not be opened since the system determines the pitcher is not in position. Thus, the first sensor 12 can notify the control circuit 20 of a negative condition indicating that the removable container 4 is not present in the dispenser 2. Accordingly, the control circuit 20 can command the valve 18 to close so that fluid cannot dispense into the removable container 4. This configuration can advantageously avoid the waste of fluid and prevent the dispenser 2 from dispensing fluid when there is no removable container 4 to receive the fluid.

If the change in flux of the second magnet 8 detected by the second sensor 14 is less than the predetermined value, or substantially equal to zero, the second sensor 14 can notify the control circuit 20 of a negative condition indicating that the removable container 4 is full with fluid. Accordingly, the control circuit 20 can command the valve 18 to close so that fluid cannot be dispensed into the removable container 4 (Step 108).

As discussed above, the second magnet 8 in the float housing 24 cannot move when the removable container 4 is already full with fluid because the second magnet 8 in the float housing 24 will be floating on the fluid and positioned at the top surface of the removable container 4. Thus, this configuration can advantageously avoid the waste of fluid when the removable container 4 is already full with fluid. Additionally, this configuration can prevent the dispenser 2 from dispensing fluid when the second magnet 8 is not properly functioning. For example, if the second magnet 8 is fixed and not moving properly according to the fluid level, the fluid will not dispense into the removable container 4. As another example, if the second magnet 8 is not floating on top of the fluid and lies at a bottom surface of the float housing 24, the fluid will not dispense into the removable container 4. Depending on the preset predetermined time used to calculate the change in flux, the reaction time to avoid the waste of fluid can be optimized and any potential accident can be recognized and avoided quickly. For example, if the removable container 4 is full and the predetermined time is five seconds, the dispenser 2 will only pour fluid for five seconds before stopping.

In an alternate embodiment, a single sensor 14 and a single magnet 8 configuration in a fluid supply system 1 can be achieved. This fluid supply system 1 can include similar features as discussed above but only use a single sensor 14 and a single magnet 8.

In operation of this alternate embodiment, the dispenser 2 can detect the presence of the removable container 4 in the dispenser 2 when the sensor 14 in the dispenser 2 recognizes the magnet 8 in the removable container 4. For example, when the removable container 4 is not disposed in the dispenser 2, the sensor 14 can detect the flux to be substantially zero. Under this condition, the control circuit 20 can command the dispenser 2 not to supply fluid. However, when the removable container 4 is disposed in the dispenser 2, the sensor 14 can detect the flux of the magnet 8 to be within a range from approximately 1 to 5 volts.

When the sensor 14 detects the flux of the magnet 8 to be above a certain value, the magnet 8 can be determined to be located at the bottom surface of the float housing 24. The bottom surface of the float housing 24 can be located adjacent to a bottom surface of the inner housing 22. The bottom surface of the inner housing 22 can be adjacent to the bottom surface of the removable container 4. When the sensor 14 detects the flux of the magnet 8 to be above a predefined threshold, the magnet 8 can be determined to be located near the top surface of the removable container 4. The top surface of the float housing 24 can be located adjacent to a top surface of the inner housing 22. The top surface of the inner housing 22 can be located at the top surface of the removable container 4. Thus, the flux of the magnet 8 being within a range from the predetermined value to the predefined threshold can indicate the presence of the removable container 4 in the dispenser 2 and simultaneously the level of fluid in the removable container 4.

Under this configuration, the sensor 14 can notify the control circuit 20 of the flux of the magnet 8 indicating that the removable container 4 is disposed in the dispenser 2 and the level of fluid in the removable container 4. The control circuit 20 can command the dispenser 2 to dispense fluid into the removable container 4 only if the flux of the magnet 8 is less than the predefined threshold and greater than the predetermined value.

After the system determines that the container 4 is in the dispenser, the dispenser 2 begins to dispense fluid into the removable container 4. Then, the sensor 14 can detect the change in flux of the magnet 8 as discussed above. The dispenser 2 can maintain the flow of fluid to the removable container 4 only if the flux of the magnet 8 is less than the predefined threshold but greater than the predetermined value and the change in flux of the magnet 8 is greater than a predetermined amount.

The dispenser 2 can stop the flow of fluid to the removable container 4 when any of the following conditions occur. First, when the removable container 4 is not present in the dispenser 2 (when the flux of the magnet 8 detected by the sensor 14 is substantially zero). Second, when the flux of the magnet 8 is substantially equal to or greater than the predefined threshold, indicating that the removable container 4 is full with fluid. Third, when the change in flux of the magnet 8 is below a predetermined amount.

This configuration can achieve all the advantages discussed above. Additionally, by detecting the flux of the magnet 8, this configuration can prevent any fluid from entering the removable container 4 when the removable container 4 is filled with fluid. This configuration also consolidates the use of multiple magnets and multiple sensors providing for a compact and cost efficient product.

It should be appreciated that various features disclosed above and other features and functions, or alternatives thereof, may be desirably combined into many other devices. Also, various alternatives, modifications, variations or improvements therein may be subsequently made by those skilled in the art, which are also intended to be encompassed by this disclosure.

What is claimed is:

1. A dispenser and removable container system, the system comprising:
a removable container comprising a first magnet and a second magnet;
a dispenser defining a cavity to receive the removable container, the dispenser comprising:
a sensor disposed adjacent to the cavity;
a liquid supply line that is configured to supply fluid to the removable container;
a valve that regulates an amount of fluid dispensed from the liquid supply line into the removable container; and
a control circuit configured to:
open the valve and supply the fluid through the liquid supply line to the removable container in response to the sensor (1) detecting a presence of the first magnet and (2) detecting that a change in flux of a second magnet is greater than a predetermined amount.

2. The dispenser and removable container system of claim 1, wherein
the sensor comprises a hall effect sensor.

3. The dispenser and removable container system of claim 1, wherein
the sensor detects the first magnet indicating that the removable container is present in the cavity of the dispenser.

4. The dispenser and removable container system of claim 1, wherein
the sensor detects the change in flux of the second magnet within a predetermined time period.

5. The dispenser and removable container system of claim 1, wherein
the control circuit closes the valve and prevents the supply of fluid to the removable container in response to the sensor detecting the change in flux of the second magnet to be substantially zero.

6. The dispenser and removable container system of claim 1, wherein
the control circuit closes the valve and prevents the supply of fluid to the removable container in response to the sensor detecting the flux of the first magnet to be substantially zero.

7. The dispenser and removable container system of claim 1, wherein
the removable container including a cover, and
the first magnet is disposed in the cover.

8. The dispenser and removable container system of claim 1, wherein
the removable container includes an inner housing, the inner housing having a plurality of holes to allow the fluid to enter the inner housing, and
the second magnet is disposed in the inner housing and floats on top of the fluid.

9. The dispenser and removable container system of claim 8, wherein
the inner housing includes a float housing,
the float housing having a cap which secures the second magnet in the float housing.

10. The dispenser and removable container system of claim 1, wherein
the sensor includes a first sensor and a second sensor,
the first sensor detects the presence of the first magnet, and
the second sensor detects the change in flux of the second magnet.

11. The dispenser and removable container system of claim 1, wherein
the first magnet and the second magnet are separate magnets.

12. The dispenser and removable container system of claim 1, wherein
the first magnet and second magnet are the same magnets.

13. A system that supplies fluid, the system comprising:
a removable container having a magnet;
a dispenser defining a cavity to receive the removable container;
a sensor disposed adjacent to the cavity; and
a control circuit configured to
supply fluid to the removable container in response to the sensor (1) detecting a presence of the magnet and (2) detecting that a change in flux of the magnet is greater than a predetermined amount.

14. The dispenser and removable container system of claim 13, wherein
the sensor includes a first sensor and a second sensor,
the magnet includes a first magnet and a second magnet,
the first sensor detects the presence of the first magnet, and
the second sensor detects the change in flux of the second magnet.

15. A method of replenishing fluid in a removable container, the method comprising:
inserting the removable container in a fluid dispenser;
detecting, by a sensor in the fluid dispenser, a presence of at least one magnet in the removable container; and
supplying fluid to the removable container when (1) the presence of the at least one magnet is detected and (2) a change in flux of the at least one magnet is greater than a predetermined amount.
